(19) United States
(12) Patent Application Publication
(10) Pub. No.: US 2003/0120725 A1
(43) Pub. Date: Jun. 26, 2003

(54) Apparatus and method for providing a customized one-stop information service to a mobile user

(76) Inventors: Eui Sok Chung, Daejeon (KR); Soojung Lim, Daejeon (KR); Ji Hyun Wang, Daejeon (KR); Myung-Eun Lim, Jeju-si (KR); Bo-Hyun Yun, Daejeon (KR); Sang Kyu Park, Daejeon (KR)

Correspondence Address: JACOBSON HOLMAN PLLC, 400 SEVENTH STREET N.W., SUITE 600, WASHINGTON, DC, 20004, US

(21) Appl. No.: 10/277,984

(22) Filed: Oct. 23, 2002

(30) Foreign Application Priority Data
Dec. 24, 2001 (KR) 2001-84438

(51) Int. Cl. G06F 15/16

(52) U.S. Cl. 709/203

(57) ABSTRACT

In an apparatus for providing an one-stop service in a mobile web application server system a mobile terminal receives the OSS from the mobile web application server in order to use the OSS. A screen-processing module includes a java server page and a java sublet for an OSS generated in the form of a mobile web application server page. A service processing means generates an OSS log to process the OSS and represents a corresponding specialized site in the form of a service bean. An external service generates the mobile web application server system and performs a connection to OSS contents. An external system provides contents in accordance with certain information provided from the external service. A site providing system provides a corresponding specialized site to the service bean in the service processing means.

### FIELD OF THE INVENTION

The present invention relates to an apparatus and a method for providing a customized one-stop information service to a mobile user; and, more particularly, to an apparatus and a method for providing an integrated mobile Internet service to generate contents appropriate for a mobile terminal display by sharing various services having certain limitations in common.

### BACKGROUND OF THE INVENTION

Normally, a mobile service provides one specialized domain service to a mobile user. That is, currently provided services are limited to services such as movie reservations, transportation reservations, and location based information services.

Also, since mobile services have been built based on separate service systems, a newly developed mobile integration system needs to be built to integrate such individual services. This becomes a reason to cause financial burden on built costs.

Furthermore, as a mobile terminal providing the mobile service should display various mobile services in a very small screen, there are technical limits to provide integrated various services, because of a limitation in providing service contents.

The mobile service technologies are disclosed in “Design of Service-Pack Framework for Procedural Information Retrieval,” dated April 2001, “Method for Providing Tour Information using Internet and PDA and Business Model therefor,” Korean publication No. 2001-78484 and “Information Aggregation and Synthesization System,” registered as U.S. Pat. No. 6,208,975.

Namely, to be specific with a description of conventional technologies disclosed above, according to “Design of Service-Pack Framework for Procedural Information Retrieval,” dated April 2001, a user in a conventional environment of Internet information retrieval experiences a process of non-continuous and multiple-step information retrieval in order to achieve a specific purpose of retrieval. Here, an information retrieval process of each level is considered as a sub-process of the specific information retrieval, and referred to as a procedural information retrieval process.

A service-pack is defined as a pack of resources for accumulating, sharing, extending and reusing experiences of procedural information retrieval of the user in the environment of Internet information retrieval. The service-pack is defined as a pack of information closely related to a specific query. The user can re-query based on the service pack such that the service-pack may be extended.

In other words, the concept of the service-pack is established based on a definition of the multiple-step information retrieval as the procedural information retrieval. Moreover, information retrieval in a mobile environment and a concept of accumulating, sharing, personalizing, extending and reusing experiences are combined into the concept of the service-pack. A framework for building a service-pack environment is designed and presented.

According to the Korea publication No. 2001-78484, a PDA, which is not just an organizer as a separate apparatus but a member of a huge network referred to as Internet, is being developed as an apparatus for performing integrated functions of communication, entertainment, personal information management and office sheet in the market. Currently, various trials, such as a use of communication module for wireless communication and voice communication, and an installation of bluetooth for communication with peripheral devices, are being performed. Therefore, a loading of contents about geographical tour information on the PDA that is able to connect to Internet will provide convenience for foreign tourists, and a loading of cell phone functions thereon can improve communication with foreigners, communication of foreigners and an effectiveness of tour.

The prior art U.S. Pat. No. 6,208,975 provides aggregation and packaging of structured or unstructured information from disparate sources such as those available on a network such as the Internet. A network compatible/addressable interface device is operated by a user. The network interface device communicates with local data stores or network accessible data stores via an addressing scheme such as uniform resource locator addresses (URLs) utilized by the Internet. Data passing between the network interface device and the data stores is accessed, polled and retrieved through an intermediary gateway system. Such aggregated information is then synthesized, customized, personalized and localized to meet the information resource requests specified by the user via the network interface device.

When considering conventional technologies disclosed in the prior art documents and patents, there is still a problem of technological limits in providing one integrated service to generate contents appropriate for a mobile terminal display by sharing various services having certain limitations in common.

### SUMMARY OF THE INVENTION

It is, therefore, an object of the present invention to provide an apparatus and a method for one-stop information service in order to generate appropriate contents for a mobile terminal screen by sharing various services based on specific limitations.

In accordance with one aspect of the invention, an apparatus for providing an one-stop service (OSS) in a mobile web application server system, including:

a mobile terminal for receiving the OSS from the mobile web application server in order to use the OSS;

a display processing module including a java server page and a java sublet for an OSS generated in the form of a mobile web application server page;

a service processing means for generating an OSS log to process the OSS and representing a corresponding specialized site in the form of a service bean;

an external service for generating the mobile web application server system and performing a connection to OSS contents;

an external system for providing contents in accordance with certain information provided from the external service; and

a site providing system for providing a corresponding specialized site to the service bean in the service processing means.

In accordance with another aspect of the invention, a method for adding a service item in a mobile web application server system having a service processing means and an external service, including the steps of:

selecting an additional service in the service processing means;

generating an OSS profile with a description of contents and characteristics of the selected service;

updating a service document type definition (DTD) after the OSS profile is generated by the service processing means;

distributing the updated service DTD;

generating a service bean by using a service bean in the service processing means after the OSS profile is generated by the service processing means;

providing the generated service bean to a site providing system; and

collecting and comprising optimal contents based on the OSS profile when a new OSS is generated in order to provide contents related to a specific service by using a contents storing management bean in the external service and a contents storing manager in the external system, after the OSS profile is generated by the service processing means.

In accordance with still another aspect of the invention, a method for providing an OSS log that is a use breakdown of an OSS in a mobile web application server system having a service processing means and an external service, including the steps of:

performing an OSS log by using profile information and past services use information of a user received from a mobile terminal;

generating the OSS log in a user manager in the service processing means;

performing a synchronization of service items included in the OSS to thereby perform an OSS configuration service in the user manager in the service processing means, after the OSS log is generated;

providing the service items as services based on a specific location by categorizing performance conditions into time/expense/location, after performing the synchronization;

maintaining and managing a user session after maintaining OSS state information by relating timing information with a purpose of the user in the user manager in the service processing means; and

learning interests of the user for a certain time by returning a personalized module of the OSS log in a personalized bean in the external service to a personalized server in an external system, after maintaining and managing the user session by using the user manager.

In accordance with still another aspect of the invention, a method for generating an OSS in a mobile web application server system having a display processing module, a service processing means, and an external service, including the steps of:

performing a display of an OSS dynamically generated by an OSS generated by using service items selected by a user and an OSS which is recommended based on the usage of a majority of users and corresponds to interests of the user;

generating the OSSs to be displayed by the display processing module in a user manager in the service processing means;

managing the OSSs after integrating limitations related to the display processing module, the limitations being processed by controlling a personalized bean in the external service; and

processing an OSS cooperation based on an OSS log including a linkage representing particulars on cooperation between services provided by the display processing module and limitations including a menu selected by the screen-processing module.

### BRIEF DESCRIPTION OF THE DRAWINGS

The above and other objects and features of the present invention will become apparent from the following description of preferred embodiments, given in conjunction with the accompanying drawings, in which:

FIG. 1 is a block diagram illustrating an apparatus for providing a customized one-stop information service to a mobile s in accordance with the present invention;

FIG. 2a shows a process for adding a service item to a mobile web application server system in accordance with the present invention;

FIG. 2b describes a process for managing an OSS log in the mobile web application server system in accordance with the present invention;

FIG. 2c depicts a process of OSS integration and cooperation to generate OSS in accordance with the present invention; and

FIGS. 3a to 3j present a detailed composition of a user interface to provide OSS in accordance with a preferred embodiment of the present invention.

### DETAILED DESCRIPTION OF THE PREFERRED EMBODIMENTS

Preferred embodiments of the present invention will now be described in detail with reference to the accompanying drawings.

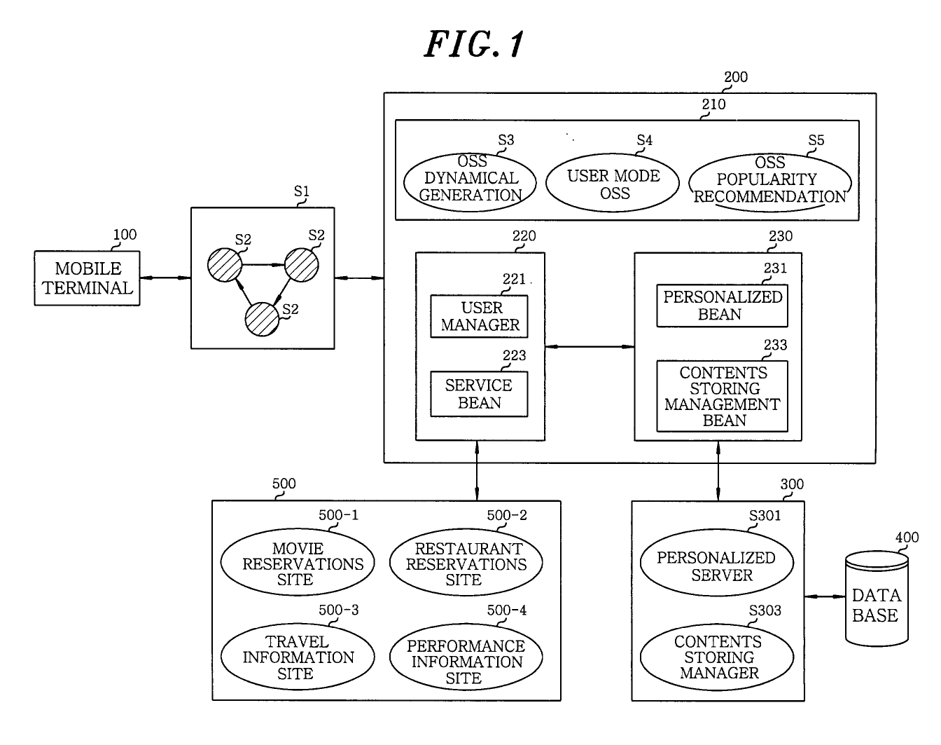

FIG. 1 is a block diagram illustrating an apparatus for providing a customized one-stop information service to the mobile user in accordance with the present invention, which includes a mobile terminal 100, a mobile web application server 200, an external system 300, database (DB) 400, a site providing system 500.

The mobile terminal 100 receives one-stop service (S1) by connecting to the mobile web application server 200 through a network (not shown) in order to use one-stop service (S1) that is composed of various lists (S2).

The mobile web application server 200, which provides one-stop service (S1) to the mobile terminal 100 through the network by being cooperated with the mobile terminal 100, includes a screen-processing module 210, a service processing 220 and an external service 230.

The screen-processing module 210, which is composed of a java server page (JSP) or a java sublet, comprises one-stop service (OSS) that is generated as a server side page form.

The service processing 220 is a block having a user manager 221 and a service bean 223, wherein the user manager 221 generates and manages OSS log that is use breakdown of OSS. After OSS log is completed by the user manager 221, the service bean 223 is connected to the site providing system 500, and indicates a corresponding specialized site as a service bean form.

The external service 230, which interfaces with the external system 300, has a personalized bean 231 and a contents storing management bean 233.

The personalized bean 231 has a role of generating the mobile web application server 200 system, and the contents storing management bean 233 undertakes a connection of OSS contents. Here, the bean is a separate component of a server in an enterprise java bean (EJB).

The external system 300 has a personalized server 301 and a contents storing manager 303. The external system 300 provides learning and contents according to various information provided by the external service 230 in a state of being connected to the external service 230 cooperated with the service processing 220.

The personalized server 301 is generated by the manager 221 in the service processing 220, and learns interests of a user according to OSS log that is use breakdown of OSS, which is provided by the personalized bean 231.

The contents storing manager 303 takes a role to prepare and provide appropriate contents for the service items with reference to one-stop service items that are stored in DB 400.

The site providing system 500, which is categorized into specialized sites, for example, movie reservations site 500-1, restaurant reservations site 500-2, travel information site 500-3 and performance information site 500-4, provides a corresponding specialized site to the service bean 223 in the service processing 220 by categorizing a corresponding specialized site.

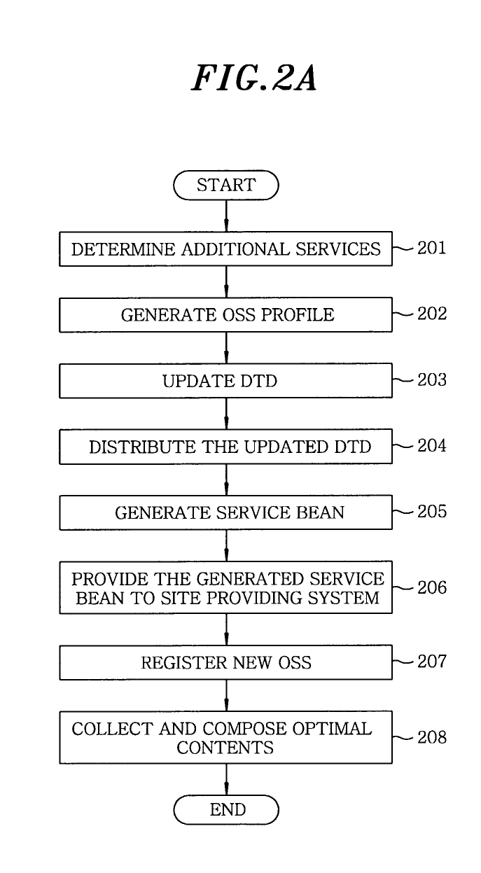

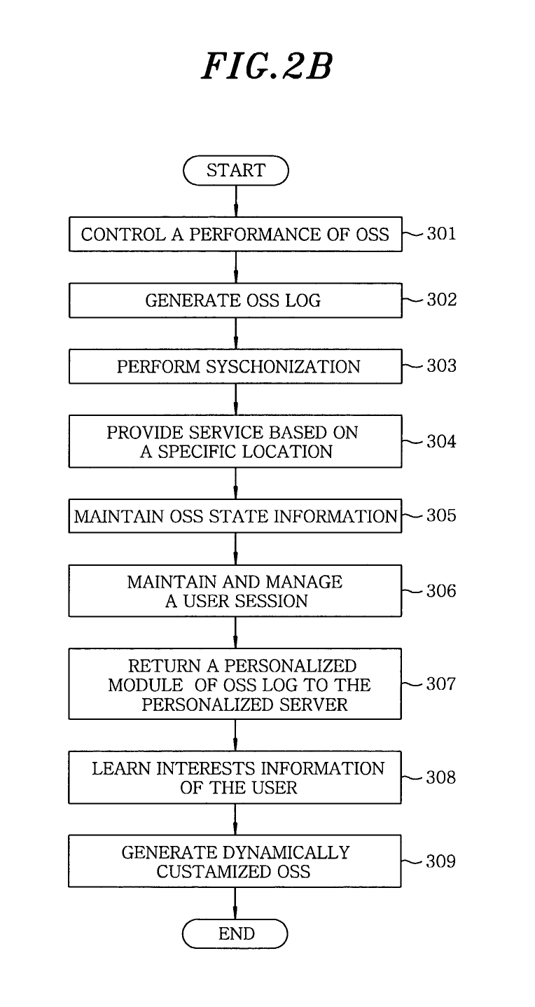

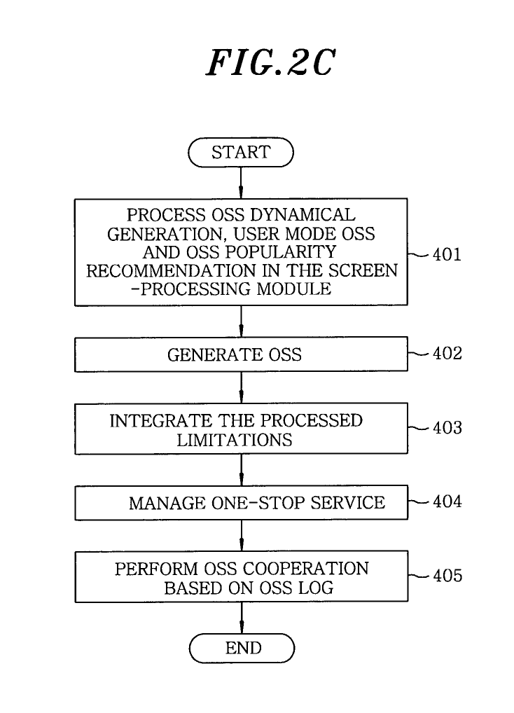

Referring to FIG. 2a, an operational process that is accompanied when a service item is added in the mobile web application server 200 system in accordance with the present invention will now be described in detail based on the composition described above.

First of all, one-stop service OSS is a meta service to integrate various services, wherein the OSS depends on configuration service items. An addition of service items means a linkage with the preset site providing system 500.

That is to say, the service processing 220 determines additional services (step 201), and generates an OSS profile with a description of contents and characteristics of services in order to generate the OSS profile (step 202), wherein the service contents include main information and additive information therefor, for example, in case of a movie reservations service, contents lists related with the movie and information needed to make a reservation for the movie. Characteristics of the service are a description of quality information that can be practically used in a personalized scheme when using main use time of the service and estimated expenses.

After the service profile is generated by the service processing 220, a document type definition (DTD) is updated (step 203). Then, the updated service DTD as a whole is distributed (step 204). The service DTD analyzes and updates OSS log information by using an OSS log information format technique that is internally used in the mobile web application server 200 system. Thus, there is no need of additional implementation works. When information of the service DTD is only added, a conventional site providing system can be still used. Therefore, the service DTD should be maintained and distributed to a personalized module and a storing manager in the mobile web application server 200 system. Besides, DTD is a XML document type, and service technique information is indicated, maintained and managed in the XML type.

Also, after the service profile is generated by the service processing 220, a service bean is generated by the service bean 223 (step 205). Then, the generated service bean is provided to the site providing system 500 by connecting to the site providing system 500 (step 206). Here, the service bean, which is a proxy server type that is able to be connected to the site providing system 500, should be able to be connected regardless of environments of various platforms and frameworks. A core function thereof is provided from the service bean.

Finally, after the service profile is generated by the service processing 220, in a registration of OSS, when new OSS is registered in order to provide contents related with a specific service by using the contents storing manager 303 in the external system 300 and the contents storing management bean 233 in the external service 230 (step 207), optimal contents need to be collected and composed by processing based on the service profile (step 208).

Referring to a flow chart of FIG. 2b, based on the composition described above, a role of OSS log that is use breakdown of OSS in the mobile web application server 200 system in accordance with the present invention will now be described in detail.

First of all, the mobile web application server 200 system, which provides customized information to the user in a mobile environment, requires a method for catching interests of a user, because the customized information is provided by learning interests of the user and reprocessing appropriate information that is determined by interests of the user.

Namely, the mobile web application server 200 system controls a performance of OSS log by using profile information of the user and past services use information of the user through the mobile terminal 100 in order to provide personalized information to the user (step 301). Here, past services use information of the user has a form of OSS use log through the result of OSS use.

The user manager 221 in the service processing 220 generates OSS log (step 302). Here, OSS log means OSS use breakdown of the user, and is composed of each of OSS that is a pack of service items generated from a demand of the user and connection contents. An OSS log technical form is determined by OSS DTD generated from the service profile, and is used in an input of a personalized module, the user session retainment and an OSS configuration service cooperation.

The OSS configuration service cooperation described above is performed by the user manager 221 in the service processing 220, and performs synchronization (step 303), which is an essential condition of service items that include OSS. Performing conditions are categorized into time/expense/location, and all services including OSS should provide services based on a specific location (step 304).

Later, the user manager 221 maintains OSS state information by corresponding timing with a purpose of a user (step 305) unlike the site providing system 500 that assumes a short-term purpose of a user, which is one of the characteristics of OSS, and maintains and manages a user session (step 306). Here, since the purpose of the user is not considered to be firmly fixed at the beginning, all interactions of users should be recorded and be able to generate new value by making use of the interactions. Thus, OSS log exists for processing a user session retainment and management.

After the user session is maintained and managed by the user manager 221, the personalized bean 231 in the external service 230 returns a personalized module of OSS log to the personalized server 301 in the external system 300 (step 307). Here, the personalized module learns interests of the user and dynamically includes appropriate OSS for a demand of the user.

The personalized server 301 learns interests information of the user with reference to the personalized module provided by the personalized bean 231 (step 308), and dynamically generates customized OSS (step 309). Here, the learning of interests of the user is performed by OSS log. Thus, OSS log should be returned to the personalized module all the time after the OSS service is completed, and the personalized module records this and performs a learning of interests of the user at a regular time.

Referring to a flow chart of FIG. 2c, based on the composition described above, OSS integration and cooperation in order to generate OSS in accordance with the present invention will now be described in detail.

Most of all, the screen-processing module 210 in the mobile web application server 200 performs a screen-process of OSS dynamical generation (S3) to generate OSS that did not exist, User made OSS (S4) which is generated by the user's choice of service items and OSS popularity recommendation (S5) generated by a recommendation of OSS that is used by a majority of users (step 401).

The user manager 221 in the service processing 220 generates OSS that is processed by the screen-processing module 210 (step 402). Here, the generation of OSS, which restricts service contents that are comprised by inputting a condition of the user, is performed by OSS limitations.

Later, the user manager 221 processes limitations corresponding to the screen-processing module 210 by controlling the personalized bean 231 in the external service 230 and then integrates the processed limitations (that is, a selected menu among the screen-processing module 210) (step 403), and manages one-stop service composed of various lists (S2) (step 404).

Later, an OSS cooperation is performed based on the OSS log including limitations having the selected menu among the screen-processing module 210 and linkage which means cooperation particulars of a service provided by the screen-processing module 210 (step 405). Here, the service cooperation provided by the screen-processing module 210 is performed based on the OSS log internal information. Limitations and linkage in the OSS log are used for a level 1 service cooperation and a level 2 service cooperation, respectively, wherein the level 1 service cooperation means a global control of OSS by limitations, and the level 2 service cooperation means a cooperation between services of connection service and limitations according to service linkage (time/location/expense). Timing superposition and distance adjacency of each service item are applied to the level 2 cooperation.

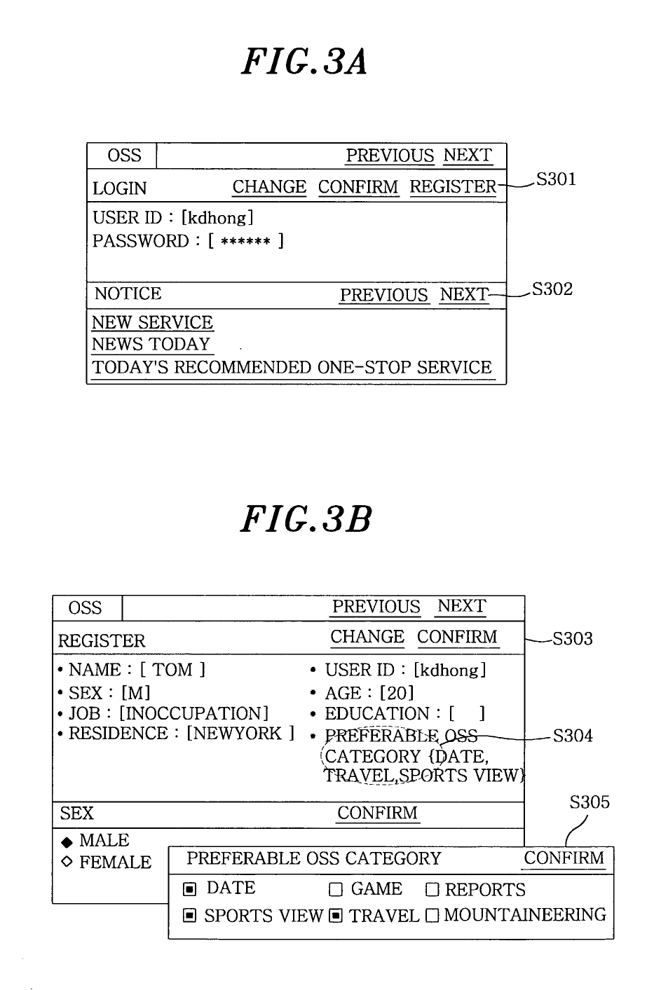

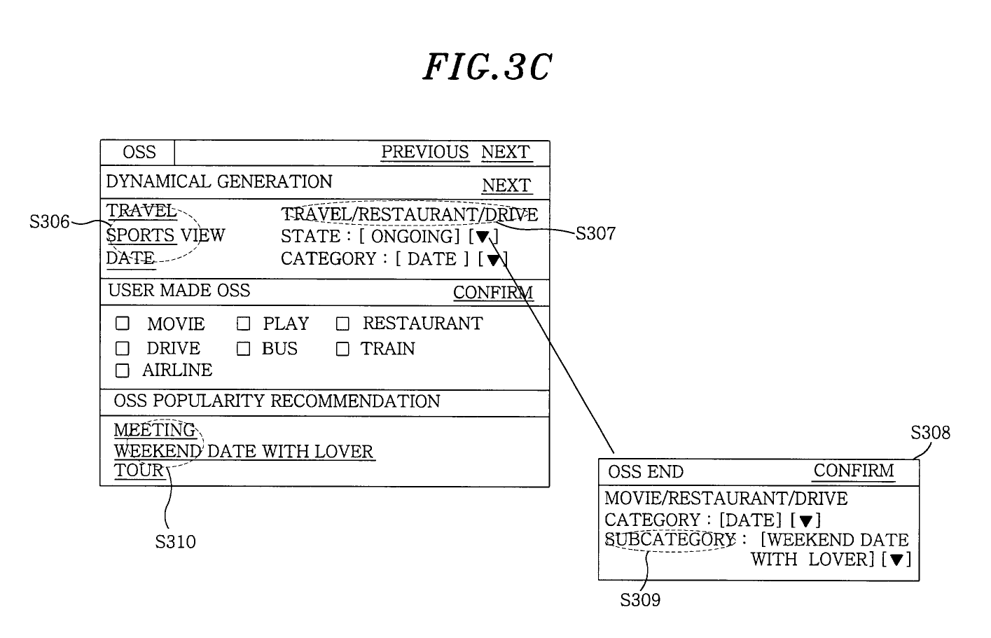

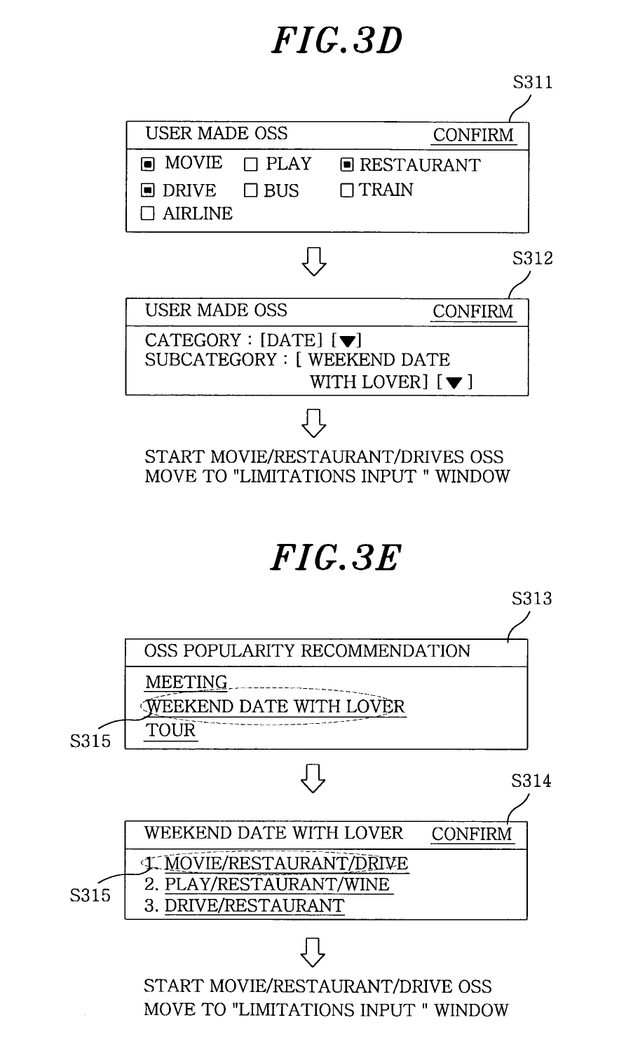

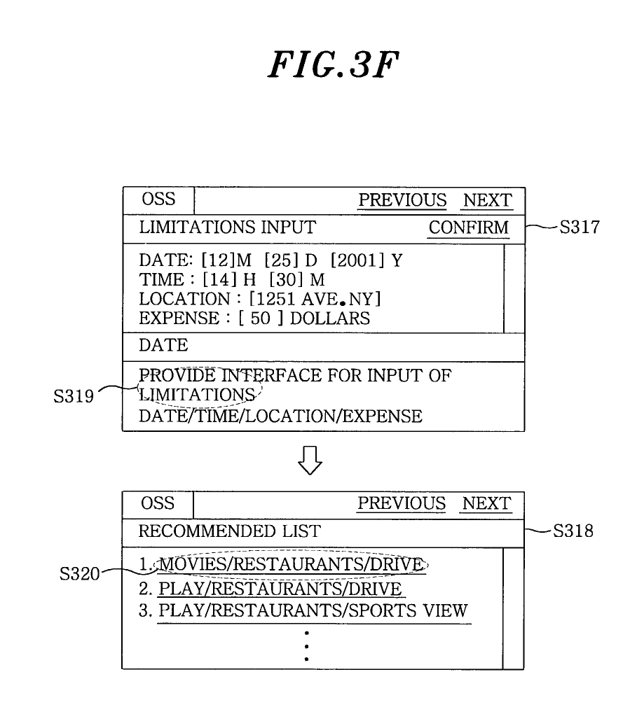

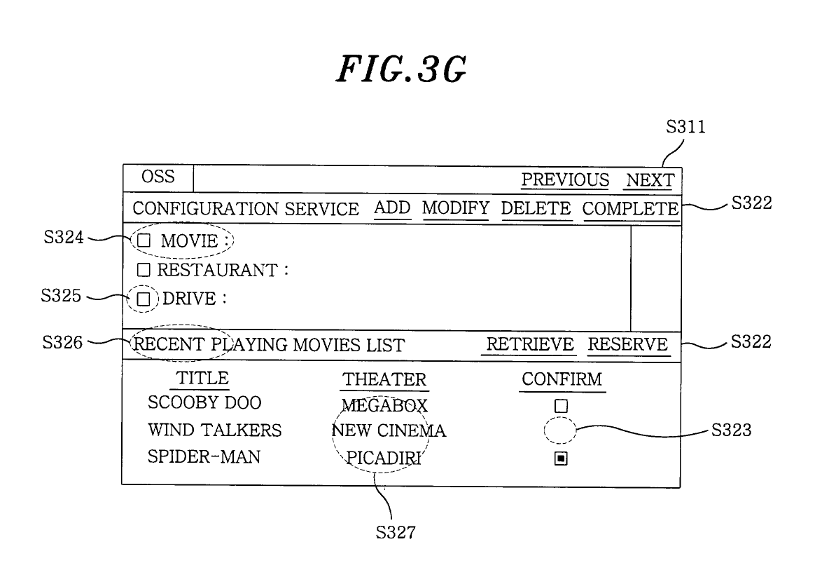

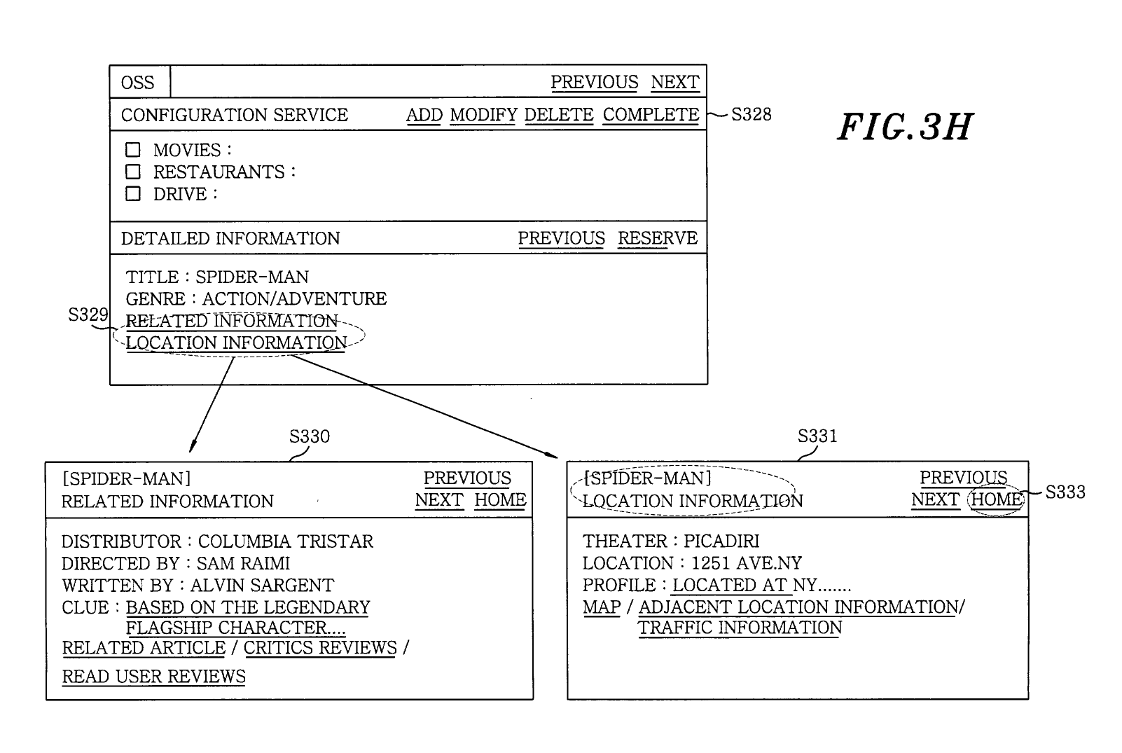

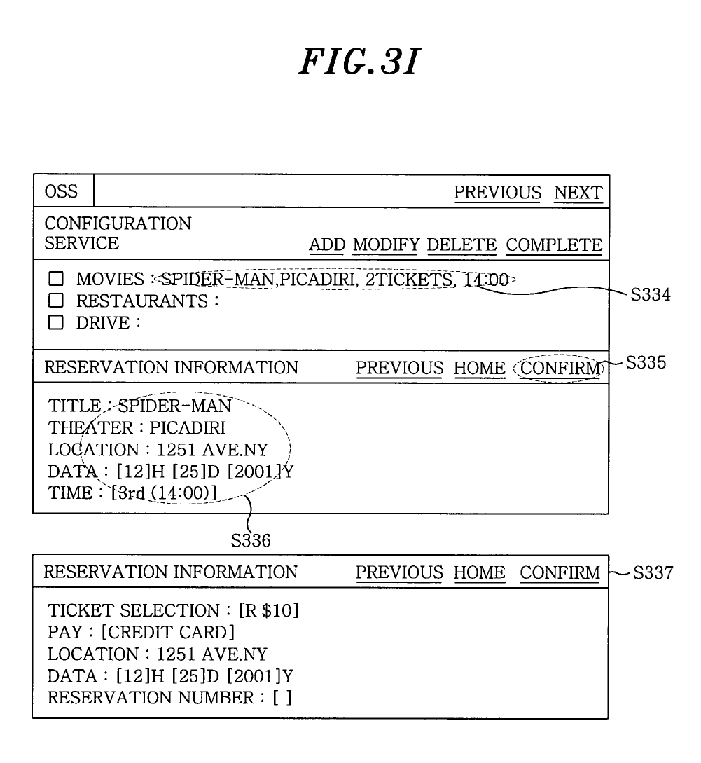

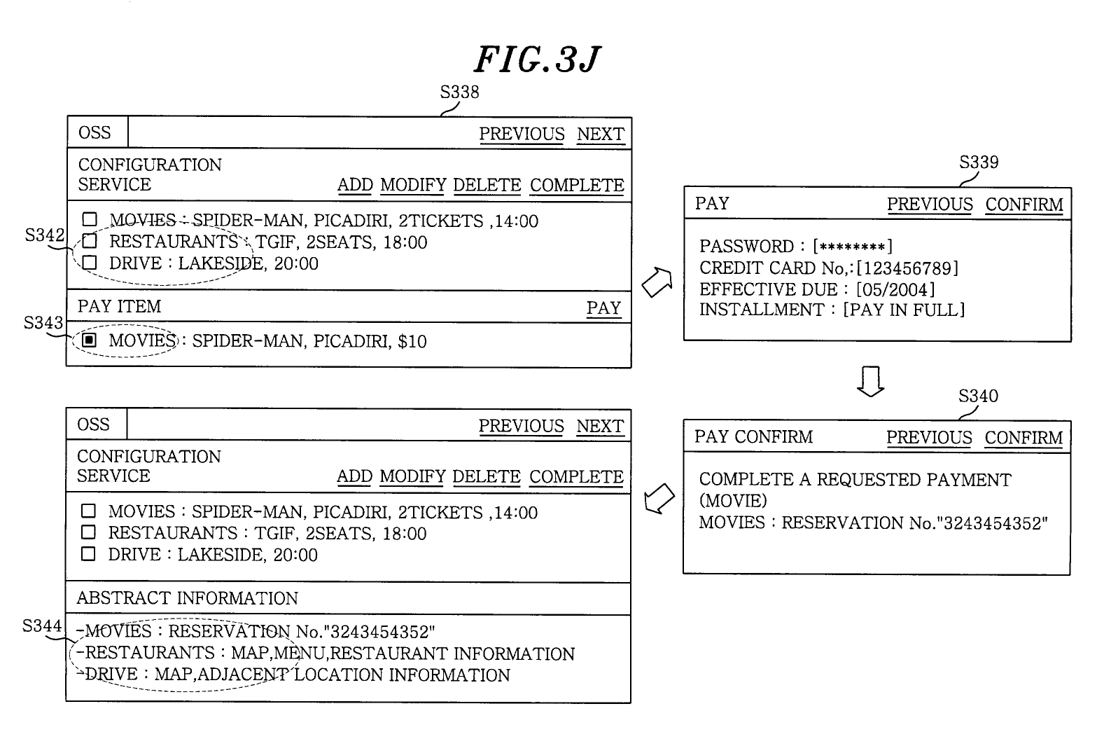

For reference, a configuration of a user interface to provide OSS in accordance with a preferred embodiment of the present invention illustrated in FIGS. 3a to 3j will now be described in detail.

First, FIG. 3a shows the user login window. A user ID and a password are inputted in a login frame (S301), and an official announcement frame (S302) shows an official announcement of one-stop service.

Besides, FIG. 3b shows both a register window (S303) provided at a time when a register button in FIG. 3A is clicked and a detailed relation category (S305) window. Here, a menu type of the preferable OSS category (S305) is popped up by selecting a preferable OSS category (S304).

Next, FIG. 3c, as a next window of a user login window illustrated in FIG. 3a, shows an OSS generation menu and an OSS currently being processed (S307). Here, in case of completing an OSS state, an OSS completion (S308) window is shown. Further, when choosing a OSS subcategory (S309) item, it is used as OSS recommendation lists (S310). The lists are comprised of OSS dynamical generation (S3) existing in the screen-processing module 210, User made OSS (S4) and OSS popularity recommendation (S5), wherein a beginning of OSS dynamic generation (S3) is performed by selecting of an OSS category (S306).

Next, FIG. 3d is a window to show a method for using User made OSS (S4) in FIG. 3c, wherein menus of User made OSS (S4) window are service items that are able to comprise OSS. Here, when choosing preferable service items, OSS generation is performed by selecting a category and a subcategory as in a window (S312).

FIG. 3e is a window to show a method for using OSS popularity recommendation (S5) in FIG. 3c, wherein the OSS popularity recommendation (S5) is comprised of OSS subcategory (S315) lists. When choosing these lists, a window that OSS lists (S316) comprising each subcategory are listed (S314) is shown.

FIG. 3f shows an input window of limitations (S317) and an OSS recommendation window (S320) that are performed after choosing OSS dynamical generation (S3) in FIG. 3c. Input interface of the limitations is provided for a convenience of inputting limitations.

FIG. 3g shows service items (S321) comprising OSS and a start menu (S322) when choosing one of the OSS recommendation lists in FIG. 3f. When a movie reservations service (S324) is comprised of one service item, an addition, a change, a deletion and a completion of each list are performed by choosing a check box (S325) of each service item.

As an example of an initiated window of the movie reservations service (S324), recent playing movie lists (S326) are being shown. Here, presented theater names (S327) are given based on a location condition of limitations. An advanced search or a reservation is performed by selecting a check box (S323) that is supposed to select one of the lists.

FIG. 3h is a window to show detailed information when choosing one of the “recent playing movie lists” of the start menu of FIG. 3g. Contents of the detailed information are included in OSS configuration (S328). Here, detailed information is presented hierarchically due to a restriction in a screen display of a mobile terminal (S329). Also, a movie information (S330) window and a local information (S331) window are contents shown when choosing detailed information respectively, and when indicating information hereof, contents lists indication (S332) is located at a title line. Here, if the start menu (S333) is selected, service initiated lists are returned.

FIG. 3i is a window that reservation information is inputted in, and when it is comprised of an input of necessary information (S336) for performing a reservation for selected reservation lists, a window (S337) shows an extended window by a scroll bar. If confirm (S335) is selected, an OSS reservation waiting state (S334) is shown by being stored in a reservation cart.

Finally, FIG. 3j, which is a window showing a processing of inputted deciding information after FIG. 3i, shows a window that contents selection of all OSS configuration service items and reservation lists input are completed (S338). Here, a part that needs a deciding process (S343) is shown arranged, and the deciding process is finally arranged in a state of all OSS services in an abstract window (S344) if a decision confirm window is confirmed as in a window (S340) after inputting lists that are necessary for a decision as in a window (S339).

Therefore, the present invention suggests a system that can be used in a mobile environment such as a PDA, and dynamically generates various services and complicated contents that are appropriate for interests of a user by providing one integrated service in order to generate appropriate contents for a mobile terminal screen by sharing various services in common with specific limitations. Also, thanks to the present invention, OSS that is a pack of complicated service items in a PDA screen can be used, and an optimal service for a wireless environment such as mobile Internet can be derived.

While the invention has been shown and described with reference to the preferred embodiments, it will be understood by those skilled in the art that various changes and modifications may be made without departing from the spirit and scope of the invention as defined in the following claims.

What is claimed is:

1. An apparatus for providing an one-stop service (OSS) in a mobile web application server system, comprising:
a mobile terminal for receiving the OSS from the mobile web application server in order to use the OSS;
a display processing module including a java server page and a java sublet for an OSS generated in the form of a mobile web application server page;
a service processing means for generating an OSS log to process the OSS and representing a corresponding specialized site in the form of a service bean;
an external service for generating the mobile web application server system and performing a connection to OSS contents;
an external system for providing contents in accordance with certain information provided from the external service; and
a for providing a corresponding specialized site to the service bean in the service processing means.

2. The apparatus of claim 1, wherein the service processing means further includes:
a user manager for generating and managing an OSS log that is a use breakdown of the OSS; and
a service bean for representing a corresponding specialized site in the form of a service bean by connecting to the site providing system after an OSS log is completed by the user manager.

3. The apparatus of claim 1, wherein the external service includes:
a personalized bean for generating the mobile web application server system; and
a contents storing management bean for managing the connection to the OSS contents.

4. The apparatus of claim 1, wherein the external system includes:
a personalized server, which is generated by the user manager in the service processing means, for learning interests of a user in accordance with an OSS log that is a use breakdown of an OSS provided through the personalized bean; and
a contents storing manager for preparing and providing contents appropriate for the service items by referring to one-stop service items stored in a database connected to the external system.

5. A method for adding a service item in a mobile web application server system having a service processing means and an external service, comprising the steps of:
selecting an additional service in the service processing means;
generating an OSS profile with a description of contents and characteristics of the selected service;
updating a service document type definition (DTD) after the OSS profile is generated by the service processing means;
distributing the updated service DTD;
generating a service bean by using a service bean in the service processing means after the OSS profile is generated by the service processing means;
providing the generated service bean to a site providing system; and
collecting and comprising optimal contents based on the OSS profile when a new OSS is generated in order to provide contents related to a specific service by using a contents storing management bean in the external service and a contents storing manager in the external system, after the OSS profile is generated by the service processing means.

6. The method of claim 5, wherein the service contents are descriptions on information needed for using information provided by the service, and wherein the service characteristics are information, which is used in a personalized scheme such as main use time and estimated expenses of the service.

7. The method of claim 5, wherein the service DTD analyzes and updates OSS log information by using an OSS log information format technique that is internally used in a mobile web application server system, and can be implemented by using the site providing system to be distributed and maintained in a personalized module and a storing manager included in the mobile web application server system.

8. The method of claim 5, wherein the DTD is a XML document type that represents, maintains and manages service technique information.

9. The method of claim 5, wherein the service bean is a proxy server capable of connecting to the site providing system regardless of various platforms and framework environments.

10. A method for providing an OSS log that is a use breakdown of an OSS in a mobile web application server system having a service processing means and an external service, comprising the steps of:
performing an OSS log by using profile information and past services use information of a user received from a mobile terminal;
generating the OSS log in a user manager in the service processing means;
performing a synchronization of service items included in the OSS to thereby perform an OSS configuration service in the user manager in the service processing means, after the OSS log is generated;
providing the service items as services based on a specific location by categorizing performance conditions into time/expense/location, after performing the synchronization;
maintaining and managing a user session after maintaining OSS state information by relating timing information with a purpose of the user in the user manager in the service processing means; and
learning interests of the user for a certain time by returning a personalized module of the OSS log in a personalized bean in the external service to a personalized server in an external system, after maintaining and managing the user session by using the user manager.

11. The method of claim 10, wherein the past services use information of the user is recorded in the OSS use log by using a result of OSS use.

12. The method of claim 10, wherein the OSS log is an OSS use breakdown of the user, which includes contents to be connected and each breakdown of an OSS having service items generated in response to a demand of the user, wherein a form of a description on the OSS log is determined by an OSS DTD generated based on a service profile, and is used in an input of a personalized module, a user session management and a cooperation between OSS configuration services.

13. The method of claim 10, wherein the purpose of the user records all interactions of the user, generates a new value by using the interactions, and operates in the form of user session retainment and management.

14. The method of claim 10, wherein the personalized module dynamically generates an OSS suitable for the demand of the user by learning interests of the user.

15. The method of claim 10, further comprising the step of generating dynamically a personalized OSS by learning interests of the user by referring to a personalized module provided from the personalized bean in the personalized server.

16. The method of claim 15, wherein the learning of interests of the user is performed by using the OSS log, wherein the OSS log is returned to the personalized module after a corresponding OSS service is completed, and the personalized module performs the learning of interests of the user during certain time by storing the OSS log.

17. A method for generating an OSS in a mobile web application server system having a display processing module, a service processing means, and an external service, comprising the steps of:
performing a display of an OSS dynamically generated by an OSS generated by using service items selected by a user and an OSS which is recommended based on the usage of a majority of users and corresponds to interests of the user;
generating the OSSs to be displayed by the display processing module in a user manager in the service processing means;
managing the OSSs after integrating limitations related to the display processing module, the limitations being processed by controlling a personalized bean in the external service; and
processing an OSS cooperation based on an OSS log including a linkage representing particulars on cooperation between services provided by the display processing module and limitations including a menu selected by the screen-processing module.

18. The method of claim 17, wherein the OSS generation is processed by using OSS limitations that confine contents of services comprised based on an input of the user's condition.

19. The method of claim 17, wherein the service cooperation provided by the display processing module is processed based on internal information of the OSS log, and used respectively in a level 1 service cooperation and a level 2 service cooperation of the limitations and the linkages included in the OSS log, wherein the level 1 service cooperation is executed through a global control of the OSS by using the limitations, the level 2 service cooperation service a cooperation between a connection service and a global condition in accordance with a service linkage, and timing superposition and distance adjacency of said each of service items are applied to the level 2 cooperation.
